(19) United States
(12) Patent Application Publication
(10) Pub. No.: US 2021/0224764 A1
(43) Pub. Date: Jul. 22, 2021

(54) PAYING ALTERNATE INTEREST RATES ON INTEREST BEARING ACCOUNTS

(71) Applicant: Kasasa, Ltd., Austin, TX (US)

(72) Inventors: Gabriel Michael Krajicek, Austin, TX (US); Donald Gordon Shafer, Austin, TX (US); Timothy Leroy Eisenman, Austin, TX (US); Paul Rudolph Barton, Round Rock, TX (US)

(73) Assignee: Kasasa, Ltd., Austin, TX (US)

(21) Appl. No.: 17/164,066

(22) Filed: Feb. 1, 2021

Related U.S. Application Data
(63) Continuation of application No. 12/171,289, filed on Jul. 10, 2008, now abandoned.
(60) Provisional application No. 60/958,924, filed on Jul. 10, 2007.

(51) Int. Cl. G06Q 20/10

(52) U.S. Cl. CPC G06Q 20/108

(57) ABSTRACT

Interest rates are applied to an account at a financial institution. A computer program determines whether the account qualifies for application of a first alternate interest rate in response to the account satisfying a first alternate interest rate qualification criteria and whether the account qualifies for application of a base interest rate. The program communicates application of the first alternate interest rate to the account for an accounting period applicable to the first alternate interest rate if the account qualifies for the first alternate interest rate. In an event wherein the account does not qualify for the first alternate interest rate, the program communicates application of the base interest rate to the account for an accounting period applicable to the base interest rate if the account qualifies for the base interest rate.

### CROSS-REFERENCE TO RELATED APPLICATIONS

This application claims priority pursuant to 35 U.S.C. 119 to U.S. patent application Ser. No. 12/171,289 entitled “PAYING ALTERNATE INTEREST RATES ON INTEREST BEARING ACCOUNTS” filed Jul. 10, 2008, which claims the benefit of U.S. Provisional Patent Application Ser. No. 60/958,924 entitled “SYSTEMS AND METHODS FOR PAYING AN ALTERNATE INTEREST ON INTEREST BEARING ACCOUNTS” filed Jul. 10, 2007, which are hereby incorporated herein by reference.

The following co-pending and co-assigned application contains related information: U.S. patent application Ser. No. 11/828,097, entitled “METHOD, SYSTEM AND COMPUTER PROGRAM PRODUCT FOR CHARITABLE CHECKING, by inventors Donald Gordon Shafer, et al, filed Jul. 25, 2007, which is hereby incorporated herein by reference.

### BACKGROUND

### Field of Invention

The present invention relates in general to systems, program products, and methods for determining the interest rate and amount to pay or accredit to an interest bearing account which may qualify for alternate interest rates based upon transactional and qualifying factors and, more particularly, based upon qualification criteria and interpretive business rules other than minimum balance.

### History of Related Art

The competitive marketplace for financial services is a constant source of innovation regarding financial products for consumers. In this context, a “consumer” or “customer” may include both a personal or commercial account at a bank, credit union, or other financial institution. Historically, interest in interest-bearing accounts was only tiered (if tiered at all) on the account holder's satisfaction of some minimum balance threshold. One more recent development was a deposit account—typically a checking account or other low/non-interest bearing account—that offered a “reward” interest rate. This reward interest rate was higher, sometimes significantly higher, than the market average for a similar type of account. A consumer, however, only earned the higher interest rate if they qualified for it. Qualification took on several forms, including some or all of the following: (1) maintaining a certain minimum account balance for a period of time (2) frequency of certain types of electronic transactions in the account, and other qualifications relating to the account. Typically, if the consumer did not qualify for the higher interest rate, the rate given to the account holder defaulted to none. Both the Federal Reserve and Federal Deposits Insurance Corporation (FDIC) questioned whether these types of accounts violated the Truth in Savings Act (“TSA”). The agencies opined that the accounts did not receive interest due to transactional infrequency. As part of their interpretation, the agencies determined that Comment 6 to Section 230.7 of Regulation DD implementing the TSA indicates that account dormancy is not a regulatory-compliant justification for a financial institution not to pay interest. The agencies argued that the only valid means of conditioning/qualifying an account holder's receipt of interest was on the satisfaction of a “minimum balance” requirement.

Accordingly, there is a need for financial services providers to come up with a new financial product that complies with the Federal Reserve and FDIC's interpretation of the TSA and Regulation DD.

Some large banks maintain their own proprietary data processing systems that reconcile and manage accounts, including providing the proper amount of interest to each account holder at the banks. Many community banks and credit unions, however, do not develop their own data processing software and/or operate their own data processing systems for reconciling and managing accounts for their customers and members, respectively, including providing the proper amount of interest paid or accrued to the account. Instead, such banks and credit unions utilize third-party “core processing” solutions. A “core processor” is a term of art in the financial services industry. The term refers to a processing system that specializes in account transactional reconciliation including but not limited to matching debit and credit transactions from activities such as cashing and writing checks, point-of-sale (POS) debits, and money transfers for an account holder at a financial institution. Thus, the core processing system is also typically tasked with determining the interest due on an account. Usually, the financial institution sets guidelines and rules for when an account holder, upon holding an amount of money in an account for a given time period, will receive an interest rate of return. This is often advertised as the estimated annual percentage yield (“APY”) for an account.

The third party core processors may facilitate core processing services to the financial institution by either (1) licensing the core processor software to the financial institution which operates the core processor software “in-house”, meaning the software is hosted and operated at the financial institution's own data center, or (2) the core processing software is operated by the core processor in a “service bureau” environment, meaning the software is hosted remotely from the financial institution or its data center at a managed hosting facility operated by a provider (the core processor or a third party licensee) that typically provides core processing services to more than one financial institution. Unless the context indicates otherwise, for purposes of this application, “core processor”, “core processing”, and other similar terms are intended to cover “in-house” operated third party core processing software, third party “service bureau” core processing services, and financial institution “core processor-like” proprietary data processing systems. Regardless of whether the bank operates its own proprietary data processing systems or utilize a third party core processor solution for all, or a portion of their processing needs, Federal laws require that the account owners and holders must be properly, promptly, accurately, and regularly informed of the status of their accounts, including earned amounts of interest on an interest-bearing account, and estimated or actual APY on the balances held in the account. The core processing system is thus heavily involved in the application and determination of account balances and interest paid or accrued to an account. A third-party information provider, such as an Internet banking solutions provider, may also be involved in the process but only from the aspect that it provides information and not as a result of any determination of interest rates or amounts.

A need exists, therefore, to permit the processing of a regulatory-compliant interest in which the rate of interest paid to the consumer account holder is conditioned on the account holder's periodic satisfaction of criteria other than just minimum balance. A need also exists to implement methods and systems to effectively pay the desired amount of interest to the account holder based upon financial institution-defined qualification criteria for a variety of software and hardware environments.

### SUMMARY OF THE INVENTION

A method is implemented in a computer system for applying interest rates to an account at a financial institution. The account is subject to a plurality of alternate interest rates and at least one of the alternate interest rates is a base interest rate and another is a first alternate interest rate. The method includes a) determining whether the account qualifies for application of the first alternate interest rate in response to the account satisfying a first alternate interest rate qualification criteria; b) determining whether the account qualifies for application of the base interest rate; c) communicating application of the first alternate interest rate to the account for an accounting period applicable to the first alternate interest rate if the account qualifies for the first alternate interest rate; and d) in an event wherein the account does not qualify for the first alternate interest rate, communicating application of the base interest rate to the account for an accounting period applicable to the base interest rate if the account qualifies for the base interest rate.

Statements herein about determination or application of reward, base, and alternate rates are intended to imply determination or application of any of an unlimited number of interest rates based on account holder satisfaction of an unlimited number of qualification criteria. Therefore, where it is stated herein, for example, that a determination is made whether a first alternate interest rate applies, this is not meant to preclude the possibility that a second alternate interest rate may also be determined to apply, unless clearly stated otherwise.

Statements made herein about a method implemented in a computer system communicating application of an interest rate are intended to include an arrangement in which the computer system implementing the method communicates affirmatively directing another computer system to apply the rate, and in which the computer system implementing the method effectively directs another computer system to apply the rate by not communicating to the other computer system.

In another aspect, a computer system determines in b) whether the account qualifies for application of the base interest responsive to whether the account balance exceeds a predetermined minimum balance. Alternatively, a computer system determines in b) whether the account qualifies for application of the base interest responsive to whether the account is of a type that always pays a base rate.

In another aspect, a), b), c) and d) are performed by a core processor and communicating application of rates in c) and d) includes a first process or routine executing in the core processor communicating with a second process or routine executing in the core processor.

In another aspect, a), b), c) and d) are performed by a program executing remotely from a core processor. The communicating in c) and d) includes the remotely executing program sending an instruction to the core processor. If the instruction has a first code, the instruction directs the core processor to apply the first alternate interest rate, so that the account nets at least the first alternate interest rate for the accounting period. If the instruction has a second code the instruction directs the core processor to apply the base interest rate, so that the account nets at least the base interest rate for the accounting period.

In another aspect, a), b), c) and d) are performed by a program executing remotely from a core processor and the communicating in c) and d) includes the remotely executing program directing the core processor to apply one or more of the alternate interest rates, wherein the core processor applies one or more corresponding rate levels for the selected one or more alternate interest rates.

It should be understood that “rate level” in this context refers to an absolute value for the rate (such as, for example 6%), and that directing the core processor to apply a “rate” in this context refers to communicating a rate type. The rate (a.k.a. rate type) is indicated by some aspect of the instruction, such as a code included therein. That is, the core processor looks up a rate level corresponding to the rate type communicated to the core processor in the instruction. Further, the rate type may indicate a rate plan.

Directing the core processor to apply one or more of the alternate interest rates may be done by the remotely executing program sending an instruction to the core processor. If the instruction has a first code, the instruction directs the core processor to apply the first alternate interest rate, so that the account nets at least the first alternate interest rate for the accounting period. If the instruction has a second code the instruction directs the core processor to apply the base interest rate, so that the account nets at least the base interest rate for the accounting period.

In another aspect, a), b), c) and d) are performed by a program executing remotely from a core processor and the core processor does not accrue nor pay interest. The remotely executing program computes a transaction amount. Also, c) includes sending a transaction for the computed transaction amount to the core processor, wherein the transaction is such that processing of the transaction by the core processor nets at least the first alternate interest rate to the account for an accounting period if a) determined the account qualifies for application of the first alternate interest rate. Further, d) includes sending a transaction for the computed transaction amount to the core processor, wherein the transaction is such that processing of the transaction by the core processor nets at least the base interest rate to the account for an accounting period if b) determined the account qualifies for application of the base interest rate.

In another aspect, a), b), c) and d) are performed by a program executing remotely from a core processor and the communicating in c) and d) includes the remotely executing program notifying the core processor of a selected one or more rate levels for the core processor to apply.

In another aspect, a), b), c) and d) are performed by a program executing remotely from a core processor. The remotely executing program determines respective levels for the alternate interest rates. The remotely executing program computes an adjustment amount responsive to the determining in a) and b), wherein the communicating in c) and d) includes the remotely executing program sending the computed adjustment amount to the core processor for the core processor to apply to an amount already accrued or paid by the core processor.

In another aspect, a), b), c) and d) are performed by a program executing remotely from a core processor and the method includes. The remotely executing program determines a level for one of the alternative interest rates responsive to three lowest checking rates in a local market.

In another aspect, a), b), c) and d) are performed by a program executing remotely from a core processor. The remotely executing program determines respective levels for the alternate interest rates. The remotely executing program computes a replacement amount responsive to the determining in a) and b). The communicating in c) and d) includes the remotely executing program sending the computed replacement amount to the core processor for the core processor to apply as a replacement amount in lieu of an amount already accrued or paid by the core processor.

In another aspect, applying an alternate interest rate includes accruing an interest amount.

In another aspect, applying an alternate interest rate includes paying an interest amount.

In another aspect, the accounting period is a qualification period, the determining in a) and b) is for the qualification period, and the qualification period corresponds with a statement cycle period.

In another aspect, the accounting period is a qualification period, the determining in a) and b) is for the qualification period, and the qualification period is asynchronous with respect to statement cycle period.

In another aspect, the qualification period is asynchronous by n days with respect to the statement cycle period.

In another aspect, the qualification period is asynchronous by one statement cycle period with respect to the statement cycle period.

In another aspect, the first alternate interest rate qualification criteria include one or more account qualification criteria and one or more account transaction qualification criteria.

In another aspect, the first alternate interest rate qualification criteria comprise one or more criteria selected from a group. The group can include, but is not limited to the following:
electronic receipt of account statements;
an e-mail address;
previous logging on to an Internet website;
meeting a minimum number of debit card transactions;
maintaining a minimum account balance;
meeting a certain number of direct deposits;
performing a number of bill pay transactions;
limiting the number of non-electronic transactions to the account;
referring a friend to the financial institution;
maintaining a qualifying deposit or loan account at the financial institution (relationship); and
maintaining a qualifying loan amount.

In another aspect, the one or more account transaction criteria comprise one or more criteria selected from a group. The group can include, but is not limited to the following:
a specified minimum number of debit card transactions;
a specified minimum number of ATM withdrawals;
a specified number of bill pay transactions;
a specified number of direct deposits; and
a specified number of direct debits.

In another aspect, the method includes determining whether a second alternate interest rate applies to the account for the accounting period responsive to one or more break point criteria. The one or more break point criteria include one or more criteria wherein the account balance exceeds a predetermined maximum balance for the period.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1a is an illustration of an embodiment for a system in which an application resides and wherein the application is for determining the applicable interest rate for an alternate interest bearing account;

FIG. 1b is an illustration of an embodiment for a system wherein the application for determining the applicable interest rate resides at a financial institution;

FIG. 1c is an illustration of an embodiment for a system wherein the application for determining the applicable interest rate resides at a financial institution's remote data processing center;

FIG. 1d is an illustration of an embodiment for a system wherein the application resides at a third-party core processor or service bureau;

FIGS. 2A, 2B, 2C, and 2D are a process flow diagram for a method wherein the application qualifies an alternate interest rate account for an alternate interest rate and adjusts the amount of interest paid or accrued by a core processor;

FIG. 3 is a process flow diagram for a method wherein the application qualifies an alternate interest rate account for an alternate interest rate and communicates a code to the core processor as to which interest rate to pay or accrue; and

FIG. 4 is a process flow diagram of a method wherein a core processor, on behalf of the financial institution, qualifies an alternate interest rate account for an alternate interest rate and pays the applicable amount of interest.

### DETAILED DESCRIPTION OF THE ILLUSTRATIVE EMBODIMENTS

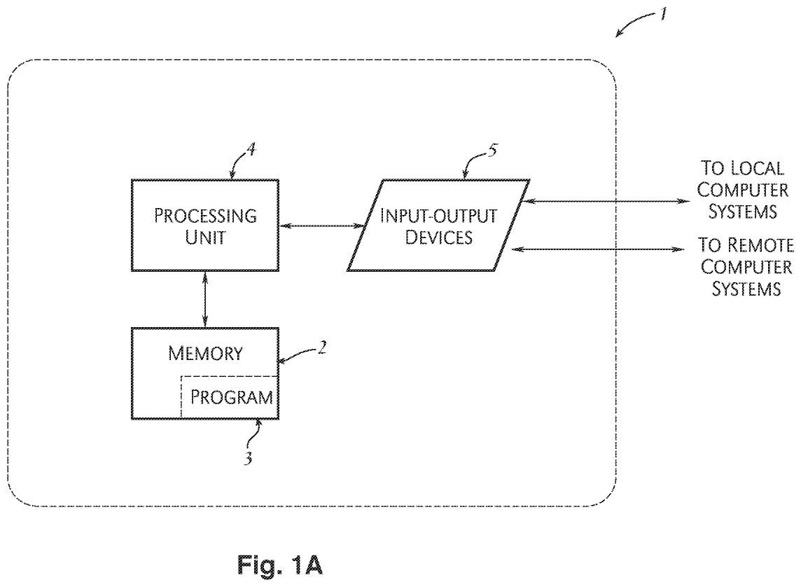

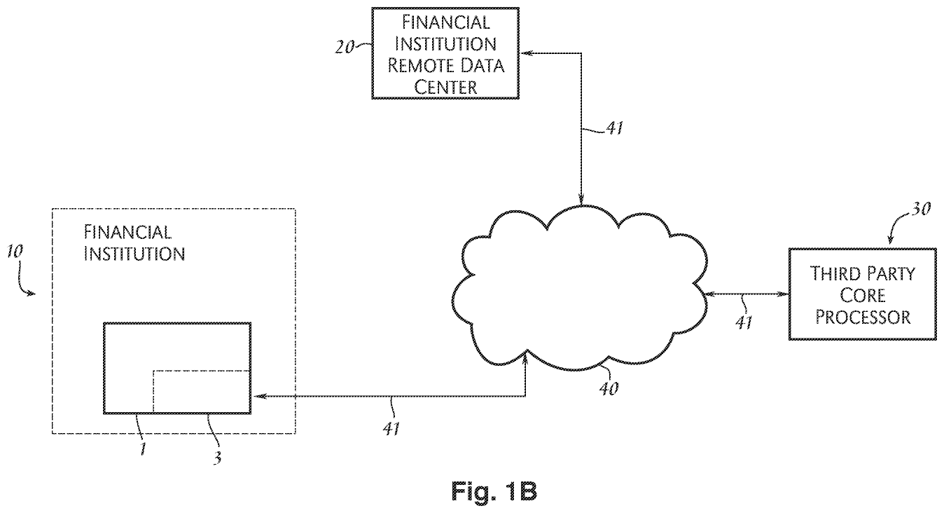

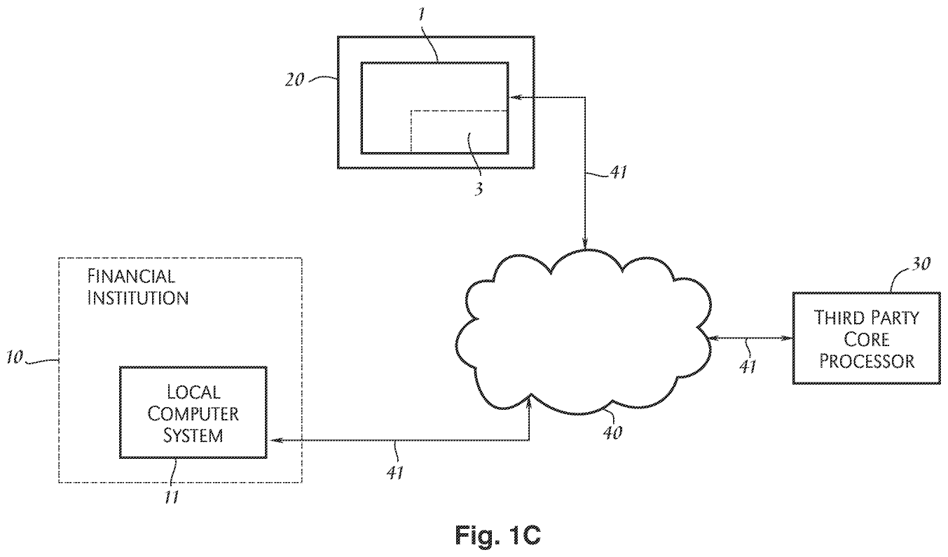

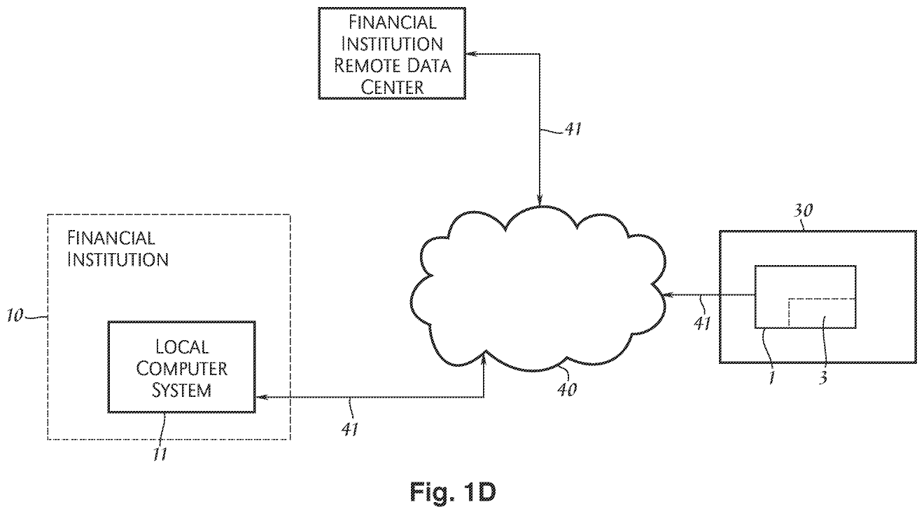

The principles of the presented embodiments and their advantages are best understood by referring to FIGS. 1-4.

In the following descriptions and examples, specific details may be set forth such as specific quantities, sizes, etc., to provide a thorough understanding of the presented embodiments. However, it will be obvious to those of ordinary skill and creativity in the art that the embodiments may be practiced without such specific details. In many cases, details concerning such considerations and the like have been omitted inasmuch as the details are not necessary to obtain a complete understanding of any and all the embodiments and are within the skills and creativity of persons of ordinary skill in the relevant art.

Unless the context indicates otherwise, for purposes of this application, “financial institution” shall be any entity that pays interest on an account, including, but not limited to, a bank or a credit union.

Unless the context indicates otherwise, for purposes of this application, an “adjustment” shall mean any interest payment, whether posted to an account or accrued to be paid to an account and which can be a partial or full amount; i.e., an adjustment credit to pay the full interest amount or an amount to increase what has already been paid or accrued or an adjustment debit to deduct the full interest amount or an amount to decrease an already paid or accrued amount.

In the embodiments, systems, program products, and methods for providing one of a plurality of alternate interest rates to an alternate interest bearing account at a financial institution are disclosed. Briefly, such an account at a financial institution may qualify for one or more predetermined alternate interest rates, including a predetermined “base” rate of interest. Qualification criteria are established for each alternate interest rate. If the account satisfies the qualification criteria for the application of an alternate interest rate during the applicable accounting period for determining the payment of interest, the financial institution pays the applicable alternate rate of interest, for example, on the average account balance. If the account does not satisfy the qualification criteria for receiving the alternate interest rate and there is no other alternate interest rate other than the base interest rate, the financial institution pays the base interest rate on the account principal during the applicable accounting period. Application software for determining if an account holder qualifies for an alternate interest rate and determining which alternate interest rate is to be paid on an account during an accounting period may be located on a computer system located at the financial institution, remotely at the institution's proprietary data processing center, at a third-party core processor data center, or at a third party service provider who provides services to the financial institution to carry out the method of the present invention. It should be understood that can interest rates can have levels according to the embodiments, systems, program products, and methods described herein. That is, in an embodiment X of the invention, for example: interest rates are tiered based on account balances, such as $1-$10,000=Rate A; $10,001-$25,000=Rate B; and >$25,000=Rate C. In an embodiment BB, for example, interest rates are based on specific account activity or qualifications levels. As an example of embodiment Y: Qualification A=Rate A; Qualification A+B=Rate B; Qualification A+B+C=Rate C; and so on. As another example of embodiment Y: Use debit card 10 times, earn Rate A. Each use of debit card, thereafter, earn additional 0.10% up to maximum rate, or unlimited. Further, embodiments X and Y are not mutually exclusive. That is, another embodiment of the invention combines some or all aspects of both embodiments X and Y described immediately above. (It should be understood that the embodiment Y described immediately above must always pay at least a non-qualifying rate to comply with FDIC regulations.)

The following table further illustrates the above. This table illustrates examples of rate plans and rate types, wherein Example X is a rate plan and Rates A, B, C, etc. are rate types that have corresponding rate levels.

TABLE ONE

| | 0-$10,000 | $10,001-$25,000 | >$25,000 |
|---|---|---|---|
| EXAMPLE X of a. and b. combined | | | |
| Qualification Activity A | Rate A | Rate D | Rate E |
| Qualification Activity B | Rate B | Rate F | Rate G |
| Qualification Activity A + B | Rate C | Rate H | Rate I |
| Qualification Activity A + B + C | Rate D | Rate J | Rate K |
| EXAMPLE Y of a. and b. combined | | | |
| Qualification Activity A | Rate A + .10% | Rate B + .10% | Rate C + .10% |
| Qualification Activity B | Rate A + .10% | Rate B + .10% | Rate C + .10% |
| Qualification Activity A + B | Rate A + .25% | Rate B + .25% | Rate C + .25% |
| Qualification Activity A + B + C | Rate A + .50% | Rate B + .50% | Rate C + .50% |

In embodiments where the account may receive more than one alternate interest rate as well as a base interest rate, the qualification criteria for the second alternate interest rate may vary from the qualification criteria for the first alternate interest rate. For example, the qualification criteria for the second alternate interest rate may be less stringent on the account holder or less favorable to the financial institution as will be discussed in more detail below. In such an embodiment, if the account satisfied the qualification criteria for the application of the second alternate interest rate during the applicable accounting period for determining the payment of interest, the financial institution pays the applicable second alternate rate of interest on the average account balance even though the account is not entitled to receive the first alternate interest rate. Alternately, the second alternate interest rate could be a higher rate and the account could qualify for both the first and second alternate interest rates. In this scenario, the account would be entitled to receive the highest of the available rates or the sum of both interest rates.

Typically, the account holders of an account at a financial institution either are paid a higher-than-market “reward” interest rate or a “base” rate of interest. Unlike the previous account designs, if an account holder does not qualify for the reward rate, the owner or holder is still guaranteed a base interest rate of earnings on the account principal (assuming that the principal is above a required account minimum amount for paying interest, if so required). Additionally, the qualification criteria for obtaining the reward interest rate is decoupled from the minimum account balance amount, thereby avoiding regulatory concern of what actions would allow an owner or holder of an account to qualify for the reward interest rate. Application software for computing the interest to be paid to the account holder or owner may be located locally at the financial institution, remotely at the institution's proprietary core data processing center, at a third-party “service bureau” core processor data center, or at a third party service provider who provides the application processing services to carry out the method of the present invention, and who may also be the core processor for the financial institution.

A novel computer program controlled process has been developed that permits a financial institution, either directly or through a core processor, to determine if an account qualifies for one or more alternate “reward” rates of interest or merely a “base” rate of interest and then either pay or accrue the determined amount of interest to the account. Alternatively, the financial institution can access the computer program application provided through a third party application service provider through suitable communications means to carry out the steps of the process.

In one embodiment, the computer program application resides remotely from the core processor, determines whether the account qualifies for an alternate interest rate during the qualifying period, determines the amount of interest to pay the account, communicates the amount to the core processor, and the core processor pays or accrues, as applicable, the interest amount to the account.

In a variation of the above embodiment, the computer program application resides remotely from the core processor, determines whether the account qualifies for an alternate interest rate during the qualifying period, determines the amount of interest to adjust the amount of the interest previously accrued or paid by the core processor, communicates to the core processor the amount to adjust the interest amount previously paid or accrued to the account, and then the core processor makes the adjustment.

In another embodiment, the computer program application resides remotely from the core processor, determines the qualification status of the alternate interest bearing account, communicates to the core processor what interest rate to pay the account, and the core processor pays or accrues the interest payment to the account based upon the interest rate provided by the application.

In another embodiment, the application resides remotely from a core processor which has been previously provided a predetermined number of alternate interest rates including the base rate for designated alternate interest accounts and the computer program application sends to the core processor a flag or other instruction (e.g., code) that the account qualifies or does not qualify for an alternate interest rate. The flag or other instruction may include an instruction for the core processor indicating what rate (i.e., “rate” in this context meaning what type of rate) to pay or accrue. The core processor then pays or accrues the applicable interest based upon whether the account qualifies for the alternate interest rate or base rate stored. This may include the core processor looking up a rate level (i.e., “level” in this context meaning an absolute value for the rate, such as, for example 6%) that corresponds to the rate (i.e., rate type) indicated by the instruction.

In another embodiment, the computer program application resides at a core processor and the core processor retrieves any necessary information from any third party regarding account qualification, determines if the account qualifies for a reward interest rate, and pays the interest rate determined based upon the qualification to the alternate interest bearing account.

The alternate interest bearing account application has one or more higher-than-market incentive interest rates, or “reward” interest rates, for qualifying accounts, and a nominal or traditional interest rate, or “base” interest rate, for those accounts that for some reason do not qualify for any rewards rate. The application also permits the financial institution to not pay any interest in those situations permitted by the applicable regulatory agencies. The purpose of the product is to encourage new consumers to join a financial institution to obtain the higher-than-market interest rate for funds that traditionally may not see high returns, such as funds held in checking accounts, which typically have a low residence time in the account and are therefore valued less by the financial institution. The product also encourages new and existing customers to provide information to the financial institution. The information provided may permit the financial institution not only to get to know their customers, but the information may also be used to lower the expenses and improve the profitability of managing such accounts. For example, by requiring users that wish to qualify for a higher rewards interest rate to use certain automated and regularly-scheduled functions such as on-line bill pay, direct deposit, direct debit, electronic statements, and e-mail addresses for sending advertisements and account notifications, the financial institution may be able to significantly lower its overhead costs (e.g., electronic statements versus paper and postage) and increase its income (e.g., charges from increased debit card usage). In essence, the financial institution may use the information provided to increase its own profits by shaving expenses and marketing costs, of which some of the profits are paid as an increased interest rate for those customers that qualify for rewards interest on their accounts.

The alternate interest bearing account complies with government regulation as set forth recently by the FDIC. In Bulletin No. CHIRO-05-2007, the FDIC warned that “rewards” checking products by some financial institutions may be in violation of Regulation DD, which implements the Truth in Savings Act, because, although a higher-than-market interest rate was awarded, some banking products eliminated interest completely if an account owner or holder did not qualify for the rewards interest rate during a particular qualifying period. The FDIC noted that financial institutions cannot eliminate the payment of interest on anything other than maintaining the minimum balance in an account and cannot require transactions of a certain dollar amount to qualify. The FDIC did note that a financial institution may do an alternate interest deposit account if conditions other than minimum balance and number of transactions are met.

In all embodiments, the alternate interest bearing account is a deposit account, such as a checking account at a financial institution that provides the owner of the account a return on a principal deposit amount either at a “base” interest rate or at a “reward” interest rate. Whether the account owner receives interest at a base or reward interest rate is dependent on several financial and non-financial factors; however, the account owner will receive a non-zero interest rate on their principal balance regardless of qualification for the higher reward rate. It should be noted that a zero interest rate return still may occur if the account owner does not meet some other metric not related to the qualifications used to determine the reward interest rate, such as an established minimum account balance.

According to Federal regulation, a “base” interest rate for an interest-bearing account must be a “bona fide” rate. An embodiment of a method for choosing a “bona fide” rate may include determining the lowest three checking rates in the local market and then setting a base rate at the highest of the three rates.

Although the thought of an alternate interest-bearing account might seem simple on its surface, implementation is not, especially when examining the different data processing functions occurring at and among a financial institution, a financial institution remote data processing center, and/or a third-party core processor. In the context of determining the proper amount of interest to credit an alternate interest bearing account, the financial institution, a financial institution remote data process center, or a third-party core processor may retain information or perform some or all of the steps. In some embodiments, one of the entities may perform all of the necessary steps to determine and pay or accrue the necessary interest to an account. The means of communications will depend on the relative relationship between the entities, what information they each retain, and what parts of the process they perform for determining and settling the account. In some embodiments, the means for account qualification, determining the amount of interest to pay, and then paying the amount due are all in the same internal system, often networked together with well-established protocols. In such embodiments, local communications through well-understood network systems such as an intranet or local area network exists. In some embodiments, the means for qualifying an account, determining an amount to be paid, and paying the amount occurs between different computer systems, some of which may be operated by different entities. In such embodiments means for communications may be used that are well understood in the art, including leased telephone lines, microwave transmission, virtual private networks over the Internet and other commonly understood methods.

According to some embodiments, a computer system determines the qualification status of an alternate interest bearing account for an interest rate, the system comprising one or more computer processors that execute application program instructions, memory storage, and ports to receive/transmit digital data. The computer system may also communicate instructions to other computers systems involved with the payment or accrual of interest to the account to adjust, pay, or accrue an amount of or percentage rate of interest based upon the qualification status determination.

FIG. 1a depicts an embodiment of a computer system 1 that determines the qualification status of an alternate interest bearing account and provides instruction to effect payment or accrual of interest in the account based upon the qualification determination. The computer system 1 includes a memory 2 for storing an application that is executed by a processing unit 4. Memory 2 also stores tables or other data needed by the computer instructions of a novel application program 3. Input/output devices 5 from the computer system 1 transmit and receive information to and from other computer systems, which may be local or remote, needed to obtain all the information necessary to determine the qualification status of an alternate interest bearing account and provide instructions as to the interest rate to be applied to an account in response to the account qualification and other data. (It should be understood that “local or remote” may imply both local and remote.)

FIG. 1b shows an embodiment of the system wherein the computer system 1 including application program 3, resides at a financial institution 10. In this embodiment, computer system 1 is able to perform the determination of qualification for an alternate interest bearing account and prove instruction to effect payment or accrual of interest in the account based upon the qualification determination through several means. The computer system 1 also may retrieve information and provide instructions to a financial institution remote data processing center 20 or a third-party core processor 30 through input/output devices 5 through communications channels 41 via a remote communications network 40. Financial institution remote data processing center 20 and a third-party core processor 30 also have suitable computer systems and communications devices to receive, interpret, and process the instructions received from computer system 1. FIGS. 1c and 1d, show embodiments where applications program 3 is stored and is executed at a financial institution's remote data processing center 20 or on a suitable computer system, (e.g., a computer system like computer system 1 of FIG. 1b) at a third-party core processor data center 30, respectively. It is understood that one of ordinary skill and creativity in the art will appreciate the variations and modifications not only to computer system 1 but also to applications program 3 that would be required in order to implement the processes at the different locations described.

According to some embodiments, the application program 3 may be licensed as a program product on a computer readable media for use in a computer system that executes the program steps of the application program 3 to perform a method for determining the qualification status of an alternate interest bearing account for an interest rate. The program product may also contain computer-readable instructions executable by the computer system to communicate instructions to other computers systems involved with the payment or accrual of interest to the account to adjust, pay, or accrue an amount of or percentage rate of interest based upon the qualification status determination.

In some embodiments, additional interest rate structures and tiers may be present that are different and separate from the base/reward interest rate structure. For example, balance level break points and above-balance interest rates may demark a deposit fund level above which the main interest rate is changed, whatever it may be. This modification to the interest rate is to either reward additional funds or discourage the accumulation of funds in an account with certain benefits by increasing or decreasing the interest rate for the funds above the additional break level. For example, a checking account may pay a reward interest rate of 6.0% APR (very high) on an account balance between $0.01 and $10,000 held for the qualifying period; however, to discourage people from using their checking accounts as a savings account, the same account may pay an APR of only 0.5% on principal amounts (the above-balance interest rate) above $10,000 (balance level break point) held for the qualifying period. These types of composite, or “blended” rate structures can be determined and incorporated into any of the embodiments presented. In some embodiments, the above-balance interest rate and the base interest rate may be different so as to not confuse consumers between the two when disclosure of all the material aspects of the account is given.

### Example 1

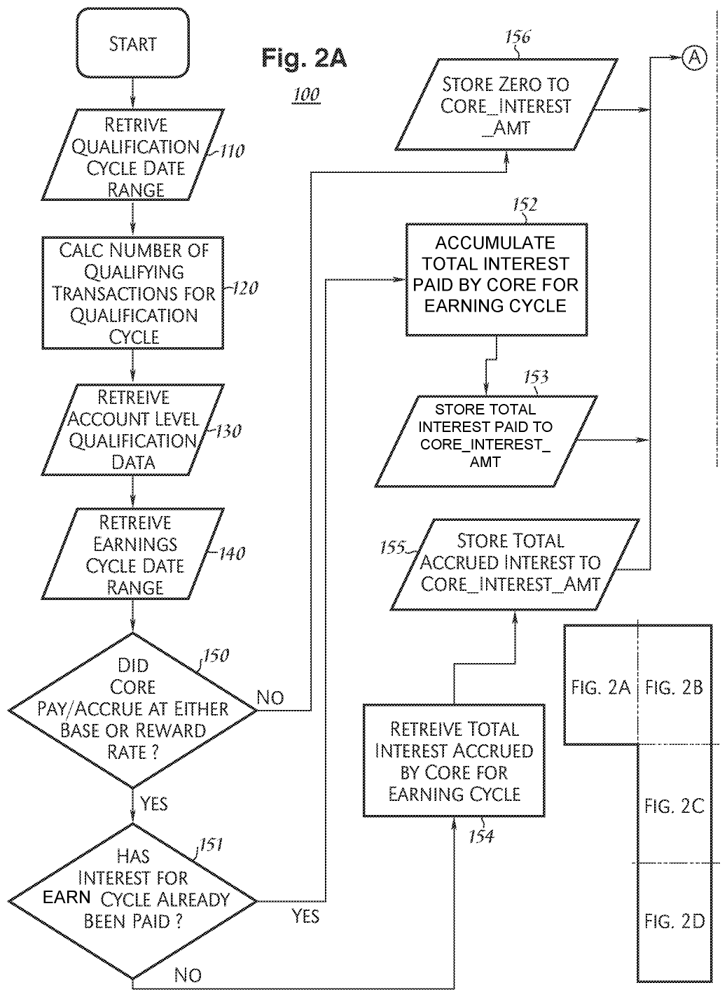

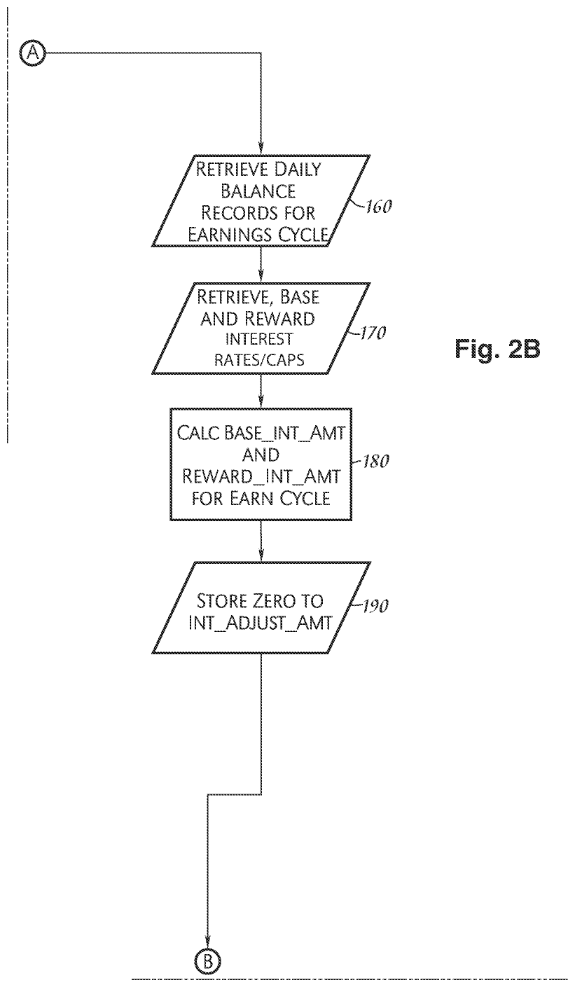

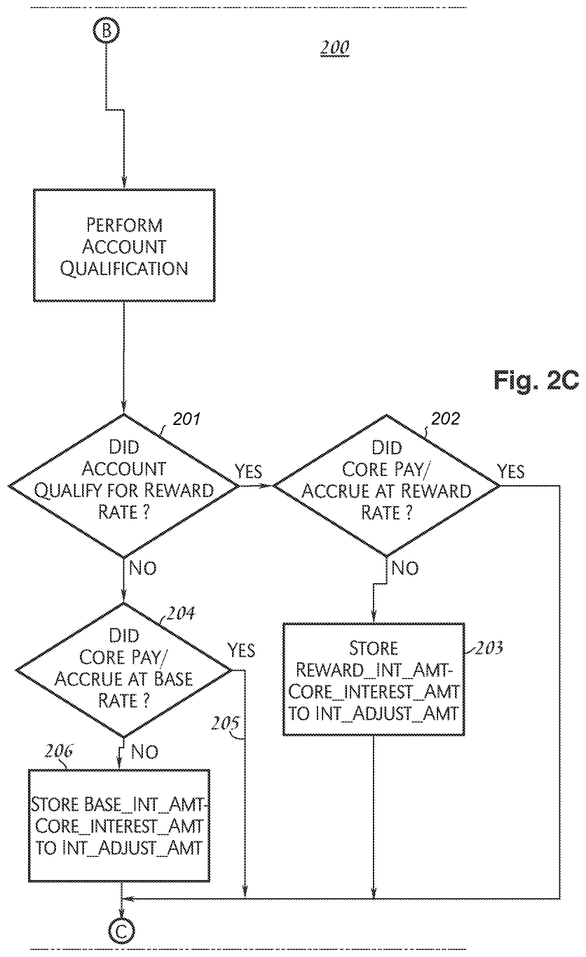

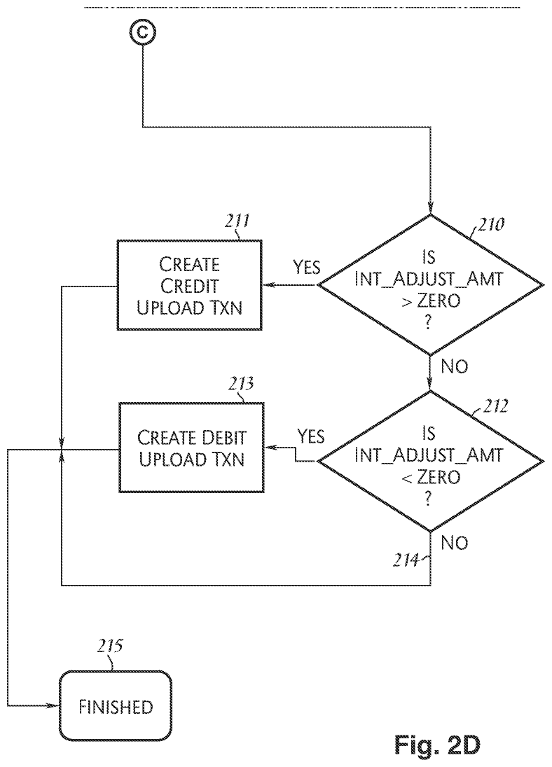

In the embodiment shown in FIGS. 2A-2D, a process 100 may be implemented by the system described in FIG. 1b or FIG. 1c where the financial institution uses a core processor to provide most of its data processing needs. Process 100 may be used to determine an amount of interest to credit an alternate interest bearing account (“account”) for a given qualification time period, to determine what has already been paid or accrued to the alternate interest bearing account and to create a transaction for communicating an adjustment, either positive or negative, from a financial institution to a remote core processor system to reflect the correct amount of interest to be paid to the alternate interest bearing account by a core processor on behalf of the financial institution. The amount of interest adjusted is based upon whether the account qualifies for a higher interest rate, known as a “reward” interest rate, or a “base” level rate, which is lower than the reward interest rate. In all embodiments, both the base and reward interest rates are positive values, i.e., not “zero”.

Process 100 in some embodiments may start with a step 110 to determine the qualification cycle date range. The qualification cycle date range is the period of time used to measure whether the owner of the account has performed the necessary steps to qualify to receive a higher interest rate on the funds. In some embodiments, the information used to determine date range may be acquired locally, e.g., a database of prior periods. In some embodiments, the information used to determine the date range may be acquired remotely, e.g., through communications with a remotely located internal data processing system or the third-party data center, such a core processor, that indicates the new or prior period.

The qualification cycle date range may be determined using several methods, which relate to other date ranges. These other date ranges include a statement cycle and an earnings cycle date period. Specifically, an account balance and interest statement is prepared periodically. The cycle for preparing this statement is referred to herein as the “statement cycle.” Likewise, there is a cycle for which earnings on interest are computed. This is referred to herein as the “earnings cycle” or the “earnings cycle date period.”

In various embodiments of the invention, the qualification cycle and earnings cycle are offset with respect to the statement cycle. Specifically, the qualification and earnings cycles may be synchronous with respect to one another but offset with regard to the statement cycle or they may be offset both with respect to the statement cycle and with respect to one another.

To use the qualification cycle as an example, in some embodiments, a time period may be used beginning one day prior to the current statement cycle (i.e., a day before the current account balance and interest statement will be prepared) though one day prior to the close of the current statement cycle. This time period may also be known as a “one-day asynchronous” period with regard to the qualification cycle, since the qualification cycle time period is off-set from the statement cycle time period (closing to closing) by one day, or n days. In some embodiments, a time period for the qualification cycle encompassing the same time period as the prior statement cycle may be used. This time period may also be known as a “one month asynchronous” period, or more generally a “one-cycle asynchronous” period, with regard to the qualification cycle, where the qualification occurs from the actions in the prior statement cycle month but are adjusted in the current statement cycle month. In some embodiments, a “synchronous” method may be used, wherein qualification for the higher interest rate occurs concurrently with the statement cycle.

Likewise, the earnings cycle may be one or n days asynchronous with respect to the statement cycle, one cycle asynchronous, or synchronous. Consequently, the earnings cycle may or may not be synchronous with the qualification cycle. It will be apparent to one of ordinary skill and creativity in the art that other means and techniques may be used to determine a period for judging account qualification for interest rate adjustment.

In process 100, after the qualification cycle date range is determined a step 120 may be made to determine the number of qualifying financial transactions occurring in the potentially qualifying account during the qualification cycle date range. In some embodiments, qualifying financial transactions may be scanned for a given interest bearing account to determine the total number of qualifying financial transactions. Examples of potentially qualifying financial transactions in this and other embodiments may include but not be limited to using an account debit card to perform a POS transaction, using an account access device (such as the computer or the phone), paying bills directly from the alternate interest bearing account, and using the alternate interest bearing account to directly perform auto crediting and debiting of the account. In some embodiments, the qualifying transactions data may be obtained from a core processor or a third party information source before the determination is made locally.

After the number of qualifying transactions has been determined, a step 130 may be made to determine the account qualification data for the account. In some embodiments, account qualification data may be obtained from a core processor or a third-party source. In some embodiments, account qualification data may relate to information about the owner or holder of the account. Examples of such data may include whether the account holder receives account statements electronically, whether an e-mail account for use with financial institution transactions has been provided, or whether the account holder has logged into an internet banking website. In some embodiments, account qualification data may relate to information about the account relating to financial transactions. Examples of such information may include meeting a required minimum amount of debit card transactions, maintaining a minimum account balance (daily and period average), reaching a maximum number of direct deposits, performing a minimum number of bill pay transactions, limiting the account to a maximum number of non-electronic transactions, or maintaining a qualifying loan amount. It will be apparent to one of ordinary skill and creativity in the art that other information may be used to determine what information could be used to provide a metric for account qualification.

In process 100, after the account qualification data has been determined a step 140 may be made to determine the earnings cycle date period by obtaining the earnings cycle date range. The earnings cycle date range is the period of time in which interest has been or will be paid to the account. In some embodiments, the earnings cycle date range is the same as the qualification cycle date range. In some embodiments, the earnings cycle date range may be obtained from a core processor or a third party information source before the determination is made locally.

After the earnings cycle date period has been determined, a step 150 may be made to determine if the core processor has paid or accrued interest on the account for the earnings cycle date range, and, if so, Step 151 is made to determine if the interest has already been paid and a step 152 to determine what that amount is. The core processor interest amount is the amount of interest that the core processor has already paid or accrued to alternative interest rate account during the earnings cycle date period. In some embodiments, the core processor interest amount may be obtained from the core processor or from a third party information source using the communications means previously detailed.

If it is determined that the core processor has already paid or accrued interest on the account during the earnings cycle date range, a step 152 is made to determine the amount of interest for the account already performed by the core processor. In some embodiments, if the core processor has already paid interest to the account based upon an interest rate during the earnings cycle date range, a step 152 is taken where the amount paid by the core processor is determined, and a further step 153 is made to note the total amount already paid for future adjustment to a core interest amount. In some embodiments, if the core processor has only accrued an amount of interest for the account at an interest rate but has not paid it, a step 154 is taken where the amount accrued by the core processor is determined and a further step 155 is made to note the total amount of interest accrued by the core processor to the core interest amount. In some embodiments, if interest has not been either paid or accrued by the core processor (e.g., the core processor does not calculate interest), a step 156 is made wherein a value of “0” is noted to the core interest amount.

After the earnings cycle date period has been determined, a step 160 may be made to retrieve daily balance records for the earnings cycle date period. In some embodiments where the daily balance is used to determine an alternate interest rate separate from the qualifications alternate interest rate, to be paid on the account, daily balance records must exist for the earnings cycle date period in order to calculate both the qualification level interest amount and the balance level interest amount. In some embodiments, the daily balance records may be obtained from a core processor or a third party source before the determination is made locally.

After the daily balance records for the earning cycle date period has been retrieved, a step 170 may be made to retrieve both the “base” and the “reward” interest rates for the alternate interest rate account.

In some embodiments, additional interest rate structures and tiers may be present based beyond the base/reward rate structure. In some embodiments, additional tier levels and interest rates may be determined based upon other criteria, such as the amount of funds in the account. This may be reported to the core processor as balance level break points and above-balance interest rates. In some embodiments the balance level break points and above-balance interest rates may be different between the rewards and base accounts.

In some embodiments where the daily balance is used to determine the interest paid on the account, daily balance records must exist for the earnings cycle date period in order to calculate both the base and rewards level interest amounts. In some embodiments, the daily balance records may be obtained from a core processor or a third party source before the determination is made locally.

After determining the base and the reward interest rates, a step 180 may be made to determine both the base and the reward interest amounts for the earnings cycle period. In a determination to be made further along in the process, accounts that qualify for a rewards interest rate for the qualifying period will receive the rewards interest amount; those accounts that do not will receive the base interest amount. In some embodiments, a daily balance method may be used to determine the base and reward interest amounts for the earning cycle period. In some embodiments, an average daily balance method may be used to determine the base and reward interest amounts for the earning cycle period. In some embodiments, balance level break points and above-balance interest rates may be included in the determination of the base and reward interest amounts for the earning cycle period.

After determining the base and the reward interest amounts, a step 190 may be made to initialize an interest adjustment amount to a value at “0”. The interest adjustment amount may be used in some embodiments to adjust the amount of interest accrued or paid to an account handled by the core processor based upon whether the account qualifies for the rewards level of interest payment or not.

After initializing the interest adjustment amount to a “0” value, a step 200 may be made to determine if the account qualifies for receiving the reward level of interest rate during the qualification cycle date range. In some embodiment, the comparative determination is made based upon the data and information acquired during steps 110, 120, and 130. The determination made in step 200 may be used to credit or debit an account based upon whether the account qualifies or does not for a reward interest rate and whether a core processor has either paid or accrued an amount that is reflective of the rate of interest to be paid to the account.

If, in step 200, it is determined that the account qualifies for a reward interest rate, a step 201 may be made to then compare the amount the core processor has previously paid or accrued to the account using the core interest amount versus what the reward interest amount is for the earning cycle period. In some embodiments, if the core processor has paid or accrued to the account at the reward rate of interest, then a step 202 is taken to bypass any adjustments to the amount paid or credited to the account by the core processor. In some embodiments, if the core processor has paid or accrued to the account at an interest rate that is different than the reward interest rate, a step 203 is taken, and an interest adjustment amount is determined. In such embodiments, the interest adjustment amount is the difference between the core interest amount and the rewards interest amount.

If, in step 200, it is determined that the account does not qualify for a reward interest rate, a step 204 may be made to then compare the amount the core processor has previously paid or accrued to the account using the core interest amount versus what the reward interest amount is for the earning cycle period. In some embodiments, if the core processor has paid or accrued to the account at the base rate of interest, then a step 205 is taken to bypass any adjustments to the amount paid or credited to the account by the core processor. In some embodiments, if the core processor has paid or accrued to the account at an interest rate that is different than the reward interest rate, a step 206 is taken, and an interest adjustment amount is determined. In such embodiments, the interest adjustment amount is the difference between the core interest amount and the base interest amount.

After it has been determined if there is an interest payment or accrual adjustment to the amount of interest paid or accrued by the core processor and what that amount is, a step 210 may be made wherein the interest adjustment amount is converted into a transaction for transmission to the core processor for interest amount adjustment to the account. In some embodiments, if the interest adjustment amount is greater than 0, indicating that an amount of interest to be credited to the account exists, then step 211 is taken and a credit transaction in the amount of the interest adjustment amount is created. In some embodiments, if the core processor has paid interest to the account (as determined in step 152), then step 211 creates a transaction that instructs the core processor to pay an additional interest amount to the account. In some other embodiments, if the core processor has only accrued interest to the account (as determined in step 154), then in step 211 a transaction is created that instructs the core processor to accrue additional interest on the account for future payment. In some embodiments, if the interest adjustment amount is less than 0, indicating that an amount of interest is to be debited from the account, then step 213 is taken and a debit transaction in the amount of the interest adjustment amount is created. In some embodiments, if the core processor has paid interest to the account (as determined in step 152), then step 213 creates a transaction that instructs the core processor to reverse a portion of the interest payment from the account. In some other embodiments, if the core processor has only accrued interest to the account (as determined in step 154), then in step 213 a transaction is created that instructs the core processor to deduct some accrued interest on the account. In some other embodiments, if the amount of initial adjustment amount is 0, then step 214 is made and no core processor uploading transaction is created.

At the completion of process 100 at step 215, a credit upload, a debit upload, or no upload transaction exists to adjust the interest accrued or paid to an alternate interest bearing account at a core processor to properly reflect the amount of interest to be paid to the account based upon its qualification (or lack thereof) for a higher interest rate. The process 100 may be repeated for the same or another account so as to aggregate a series of debit and credit upload transactions to be transmitted by conventional means to a core processor for batch account interest adjustment.

### Example 2

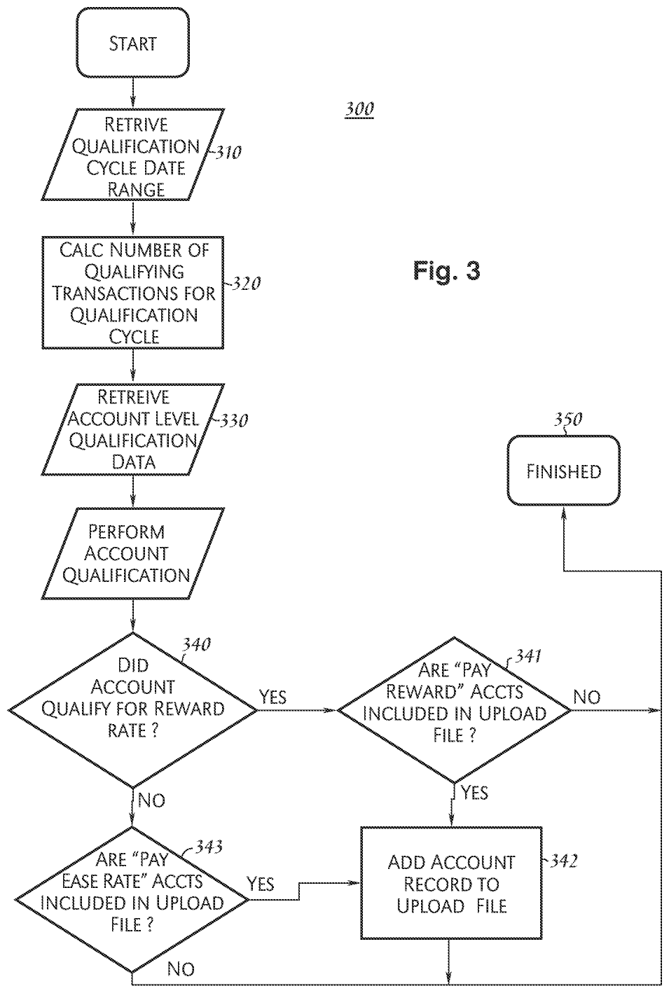

In another embodiment as shown in FIG. 3, a process 300 wherein a financial institution determines if an account qualifies for a reward level of interest rate or merely for the base level of interest rate and instructs the core processor to pay an interest rate based upon the determination. The issues and variations of the embodiment of process 300 for steps 310, 320, and 330, are similar to steps 110, 120, and 130, respectively, as described in process 100.

After the account qualification data has been determined in step 330, a step 340 may be made to determine if the account qualifies for receiving the reward level of interest rate during the qualification cycle date range. In some embodiments, the comparative determination is made based upon the data and information acquired during steps 310, 320, and 330. The determination made in step 340 may be used to credit an account based upon whether the account qualifies or does not qualify for a reward interest rate.

If, in step 340, it is determined that the account qualifies for a reward interest rate, a step 341 may be made to determine if the “pay rewards interest” accounts are to be included in a batch file upload to the core processor. This may be the case when the core processor does not automatically calculate the accrued or paid interest at the rewards interest rate. If the “pay rewards interest” accounts are not to be included in the upload to the core processor, then no record is recorded. If the “pay rewards interest” account information is to be included in an upload to the core processor, then a step 342 is made, and the account information is written to an account record for the core processor upload file. The account record may contain the necessary information to instruct the core processor to pay or accrue interest for the account on a rewards level interest basis. For example, the information may include a binary indication as to whether to pay the rewards level interest, which rewards interest rate to use, or other information such as balance level break points and above-balance interest rate adjustments.

If, in step 340, it is determined that the account qualifies for a base interest rate, a step 343 may be made to determine if the “pay base interest” accounts are to be included in a batch file upload to the core processor. This may be the case when the core processor does not automatically calculate the accrued or paid interest at the base interest rate. If the “pay base interest” accounts are not to be included in the upload to the core processor, then no record is recorded. If the “pay base interest” account information is to be included in an upload to the core processor, then a step 343 is made, and the account information is written to an account record for the core processor upload file. The account record may contain the necessary information to instruct the core processor to pay or accrue interest for the account on a base level interest basis.

At the completion of process 300 at step 350, a batch upload of account information is sent to the core processor, wherein the core processor pays or accrues interest for the accounts given the interest information for the earnings period. Process 300 may be repeated for the same or another account so as to aggregate a series of account records are recorded for upload to a core processor and transmitted by conventional means to a core processor for batch account interest adjustment.

### Example 3

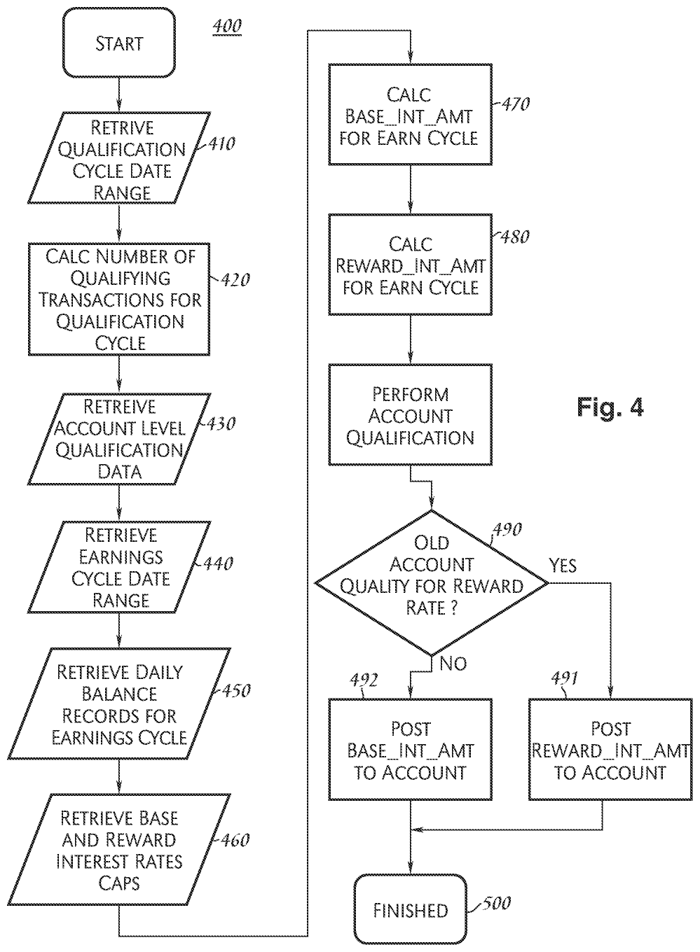

In another embodiment as shown in FIG. 4, a process 400 wherein a core processor performs the account qualification and pays applicable interest to an account after obtaining information from the financial institution or other third-party providers. Process 400 may be in many aspects similar to process 100; however, a significant difference may be that the core processor, an entity outside the financial institution, performs all the determination functions instead of the financial institution.

The issues and variations of the embodiment of process 400 for steps 410, 420, 430, and 440 are similar to steps 110, 120, 130, and 140, respectively, as described in process 100, except that the core processor may obtain information from the financial institution in process 300 whereas the financial institution obtained information from the core processor in process 100. The issues and variations of the embodiment of process 400 for steps 450 and 460 are similar to steps 160 and 170, respectively, as described in process 100, except again the core processor may obtain information from the financial institution in process 300 whereas the financial institution obtained information from the core processor in process 100.

After obtaining base and rewards interest rate information from the financial institution, a step 470 may be performed wherein the base interest amount for the earnings cycle period is determined for an account. In some embodiments, a daily balance method may be used to determine the base interest amount for the earning cycle period. In some embodiments, an average daily balance method may be used to determine the base interest amount for the earning cycle period. In some embodiments, balance level break points and above-balance interest rates may be included in the determination of the base interest amounts for the earning cycle period.

After determining the base interest amount for the earnings cycle period, a step 480 may be performed wherein the rewards interest amount for the earnings cycle period is determined for the account. In some embodiments, a daily balance method may be used to determine the rewards interest amounts for the earning cycle period. In some embodiments, an average daily balance method may be used to determine the reward interest amount for the earning cycle period. In some embodiments, balance level break points and above-balance interest rates may be included in the determination of the reward interest amounts for the earning cycle period. In some embodiments, step 470 and 480 are performed simultaneously.

In process 400, after determining the account qualification in step 480, a step 490 may be made to determine if the account qualifies for receiving the reward level of interest rate during the qualification cycle date range. In some embodiments, the comparative determination is made based upon the data and information acquired during steps 410, 420, and 430. The determination made in step 480 may be used to credit an account based upon whether the account qualifies or does not qualify for a reward interest rate.

The calculations made in steps 470 and 480 may be used to credit the account based upon whether the account qualifies or does not qualify for a reward interest rate. If, in step 490, it is determined that the account qualifies for a reward interest rate, a step 491 may be made to post the rewards interest amount, as calculated in step 480 to the account. Since the core processor directly makes the qualification determination instead of the financial institution, the core processor can automatically credit the account with the reward interest in step 500 upon finding that the account has qualified. If, in step 490, it is determined that the account does not qualify for the rewards interest rate, a step 492 may be made to post the base interest amount, as calculated in step 470, to the account and credit given to the account by step 500.

It should be appreciated by those skilled in the art, that there are numerous embodiments of the present invention. In the embodiments, systems, program products, and methods for providing a plurality of alternate interest rates to an interest bearing account of a financial institution's account holders are disclosed. Briefly, the account holders of an account at a financial institution may obtain at least one alternate interest rate or a “base” rate of interest. If an account holder does not qualify for a higher alternate interest rate, the account holder is still provided a base interest rate of earnings on the account principal provided the account meets the balance criteria for obtaining the base rate. Application software for determining if an account holder qualifies for an alternate interest rate and determining which alternate interest rate to be paid on an account during a period computing the interest to be paid to the account holder may be located locally at the financial institution, remotely at the institution's proprietary data processing center, or at a third-party core processor data center.

System

According to some embodiments, the present invention provides for a computer-based system that determines the qualification status of an alternate interest bearing account for one out of a predetermined plurality of interest rates. The computer system may also communicate instructions to other computers systems involved with the payment or accrual of interest to the account to adjust, pay, or accrue an amount of or percentage rate of interest based upon the qualification status determination.

According to some embodiments, the present invention provides for a computer system that determines the qualification status of an alternate interest bearing account for one of a plurality of interest rates and communicates to a core processor instructions to pay or credit an interest adjustment amount reflective of the determined interest rate. The system may include instructions and means for communicating with an internal data processing system to retrieve and communicate information necessary for making determinations. The internal data processing system may either be proximately located or remotely located from the computer system. The system may include instructions and means for communicating with a core processor to retrieve and communicate information necessary for making determinations.

The system may include instructions for retrieving information for and determining a qualification period based upon a qualification date range. The system may include instructions for retrieving information for and determining a total number of qualifying transactions for the qualification period. The system may include instructions for retrieving information for account level qualification data. The system may include instructions for retrieving information for and determining an earnings cycle period from an earnings cycle date range. The system may include instructions for retrieving information for and determining if an interest amount has been paid or accrued during the earnings cycle period by the core processor. The system may include instructions for retrieving information for retrieving daily balance records for the earnings cycle period. The system may include instructions for retrieving information for the base and the reward interest rates for the alternate interest rate account. The base and reward interest rates may or may not be tiered based upon account balances. The system may include instructions for determining if the account qualifies for rewards level interest or a base level of interest. The system may include instructions for determining the amount to adjust the interest amount paid or accrued, wherein the system further executes program instructions to create an upload transaction based upon the amount to adjust the interest amount paid or accrued. The system may include instructions for uploading the interest adjustment amount for the account from the financial institution to the core processor, wherein the core processor further executes program instructions to do so.

According to some embodiments, the present invention provides for a computer system that determines the qualification status of an alternate interest bearing account for an interest rate and communicates to a core processor instructions to use an interest rate, wherein the computer system includes at least a computer processor that executes program instructions and receive a digital data set. Similar to other embodiments, the system may include instructions and means for communicating with a core processor. The system may include instructions for retrieving information for and determining a qualification period based upon a qualification date range. The system may include instructions for retrieving information for and determining a total number of qualifying transactions for the qualification period. The system may include instructions for retrieving information for account level qualification data. The system may include instructions for determining if the account qualifies for rewards level interest or a base level of interest. The system may include instructions for determining if data or instructions for the core processor are to be created and uploaded to a file based on whether the account is either a “pay rewards interest” or “pay base interest” account from the prior account qualification determination, wherein the system further executes program instructions to create a file comprised of data and instructions for the core processor reflecting this determination for uploading, wherein the system further executes program instructions to do so.

According to some embodiments, the present invention provides for a system wherein the core processor includes a computer system that determines the qualification status of an alternate interest bearing account for an interest rate, calculates the amount of interest to be paid to the account, and pays an appropriate amount of interest to the account, including one or more computer processors that execute program instructions and receive a digital data set. The system may include instructions and means for communicating with either an in house core processor or a financial institution to retrieve and communicate information necessary for making determinations. The core processor may either be proximately located or remotely located from the computer system. The means for communicating with a financial institution or financial data processing data center may include locally proximate computer network structures such as data busses, intranets, and local area computer networks as well as remote computer network architectures such as wide area networks, leased telephone lines, and the Internet, the means being well understood to one of ordinary skill in the art of computer network communications. The system may include instructions for retrieving information for and determining a qualification period based upon a qualification date range. The system may include instructions for retrieving information for and determining a total number of qualifying transactions for the qualification period. The system may include instructions for retrieving information for account level qualification data. The system may include instructions for retrieving information for and determining an earnings cycle period from an earnings cycle date range. The system may include instructions for retrieving daily balance records for the earnings cycle period. The system may include instructions for retrieving information for the base and the reward interest rates for the alternate interest rate account. The system may include instructions for determining the base interest amount during the earnings cycle. The system may include instructions for determining the rewards interest amount during the earnings cycle. The system may include instructions for determining if the account qualifies for rewards level interest or a base level of interest, wherein the core processor further executes program instructions to pay the determined amount of interest based upon the account qualification determination.

Methods

According to some embodiments, the present invention provides a method for a financial institution to determine the qualification status of an alternate interest bearing account, communication to a core processor (and potentially other as of information) to instruct it to pay or credit an appropriate amount of interest to the account, and the core processor doing so, including determining a qualification period based upon a qualification date range. All information may be retrieved from the core processor using communications means. The qualification period may be determined using a n-day asynchronous method, a one-month asynchronous method, or a synchronous method. The method may include determining a total number of qualifying transactions for the qualification period. Qualifying transactions may include, but are not limited to, a specified minimum number of debit card transactions, a specified minimum number of ATM withdrawals, a specified number of bill pay transactions, a specified number of direct deposits, and a specified number of direct debits. The method may include retrieving account level qualification data. Account level qualification data may include but are not limited to such information as electronic receipt of account statements, an e-mail address, previous logging on to an internet website, meeting a minimum number of debit card transactions, maintaining a minimum account balance, meeting a certain number of direct deposits, performing a number of bill pay transactions, limiting the number of non-electronic transactions to the account, or maintaining a qualifying loan amount. The method may include determining an earnings cycle period from a retrieved earnings cycle date range. The earnings cycle period may not be the same period as the qualification date period. The method may include determining if an interest amount has been paid or accrued during the earnings cycle period by the internal data processing system or a third-party data center. The method may include retrieving daily balance records for the earnings cycle period. The method may include retrieving the base and the reward interest rates for the alternate interest rate account. The base interest rate may be determined using a method comprising determining the lowest three checking rates in the local market and then setting a base rate at the highest of the three rates. Balance level break points and above-balance interest rates may be included in either or both the base and rewards interest rate determination. The method may include determining if the account qualifies for rewards level interest. The method may include determining if the account does not qualify for rewards level interest. An interest adjustment amount may be determined as to be the difference between the base or reward interest and the paid or accrued interest amount. The method may include creating an interest adjustment transaction. If the interest adjustment amount is a positive amount, a credit upload transaction is created. If the interest adjustment amount is a negative amount, a debit upload transaction is created. The system may include uploading the interest adjustment amount for the account from the financial institution to the core processor using a communications means. The system may alternately include uploading the instructions to the core processor for which the base rate or the reward rate should be paid to the account holder using a communications means. The system may include the core processor accruing interest to the account. The system may include the core processor paying interest to the account.

According to some embodiments, the present invention provides a method for a financial institution to determine the qualification status of an alternate interest bearing account, to communicate to either its own core processor to use a provided interest rate to determine the payable interest to the account, and then the core processor to pay the interest to the account, including determining a qualification period based upon a qualification date range. All information may be retrieved from the core processor using a communications means. The method may include determining a total number of qualifying transactions for the qualification period. The method may include retrieving account level qualification data. The method may include determining if the account qualifies for rewards level interest. The method may include determining if the account does not qualify for rewards level interest. The method may include creating an account record instructing the core processor to pay base interest or pay reward interest based upon whether the account qualifies for a rewards interest rate or a base interest rate. The reward interest records may not be uploaded to the core processor. The method may include uploading account records from the financial institution to the internal data processing system or the third-party data center using a communications means. The method may include the core processor determining the amount of interest to pay from the uploaded account records and paying the proper amount of interest into the account.

According to some embodiments, the present invention provides method for a core processor to determine the qualification status of an alternate interest bearing account, calculate the amount of interest to be paid to the account, and to pay an appropriate amount of interest to the account, including determining a qualification period based upon a qualification date range. All information may be retrieved by the core processor using a communications means. The method may include determining a total number of qualifying transactions for the qualification period. The method may include retrieving account level qualification data. The method may include determining an earnings cycle period from a retrieved earnings cycle date range. The method may include retrieving daily balance records for the earnings cycle period. The method may include retrieving the base and the reward interest rates for the alternate interest rate account. The method may include determining both base interest and reward interest amounts for the earnings cycle period. The method may include determining if the account qualifies for a reward interest rate, in which the method includes posting the reward interest amount to the account. The method may include determining if the account does not qualify for a reward interest rate, in which the method includes posting the base reward interest amount to the account.

Program Product

According to some embodiments, the present invention provides for a program product for use in a computer system that executes the program steps stored in memory to perform a method as previously described.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A computer-implemented method for applying alternate interest rates to accounts at a financial institution, the method comprising:
(a) providing an interest rate plan for applying interest rates to a demand deposit account at the financial institution comprising
(i) a plurality of tiers for the demand deposit account, wherein each of the tiers correspond to account balance ranges,
(ii) non-zero base rates comprising a non-zero base rate for each tier in the plurality of tiers,
(iii) one or more rate levels, wherein
(A) each of the rate levels has qualification criteria associated therewith,
(B) the qualification criteria for each of the rate levels comprises at least one account level qualification criteria and at least one account transaction activity qualification criteria,
(C) for each rate level, each tier in the plurality of tiers has an alternate interest rate, and
(D) for each rate level, a first tier in the plurality of tiers has a first alternate interest rate that is a higher-than market interest rate;
(b) designating the demand deposit account to receive interest based on said interest rate plan;
(c) providing an application program for implementing the method in communication with a core processor system for the financial institution over a communications network;
(d) associating the core processor system with a rate type from a plurality of rate types that is suitable for communicating the one or more rate levels to the core processor system;
(e) providing at least one memory accessible by the application program that includes:
(i) the interest rate plan;
(ii) a qualification cycle date range associated with the interest rate plan;
(iii) account level qualification criteria for the one or more rate levels for the financial institution; and
(iv) account transaction activity qualification criteria for the one or more rate levels for the financial institution;
(f) accessing, via the application program, the qualification cycle date range associated with said interest rate plan;
(g) accessing, via the application program, (i) the qualification criteria for the one or more rate levels and (ii) account criteria data for the designated demand deposit account during the qualification cycle date range;
(h) determining whether the account criteria data for the designated demand deposit account qualifies the demand deposit account for the application of the non-zero base rates for an accounting period;
(i) determining, via the application program, whether the account criteria data for the designated demand deposit account meets the qualification criteria for one of the one or more rate levels for the qualification cycle date range;
(j) upon determining that the account criteria data for the designated demand deposit account meets the qualification criteria for the one of the one or more rate levels for the qualification cycle date range, instructing the core processor system to apply the alternate interest rates for the determined rate level to the designated demand deposit account for the accounting period wherein the instructing includes converting the determined rate level into a code for the core processor using the associated rate type, generating an instruction that includes the code, and sending the instruction to the core processor system to adjust the interest paid or accrued by the core processor system for the demand deposit account;
(k) upon determining (i) that the account criteria data for the designated demand deposit account does not meet the qualification criteria for any of the one or more rate levels of the interest rate plan, and (ii) that the account criteria data for the designated demand deposit account qualifies for the application of the non-zero base rates, instructing the core processor system to apply the non-zero base rates to the designated demand deposit account for the accounting period.

2. The method of claim 1, wherein the non-zero base rates comprise the same non-zero base rate for each tier in the plurality of tiers.

3. The method of claim 1, wherein the step of determining in step (i) of claim 46 is a single determination of whether the account criteria data for the designated demand deposit account meets the qualification criteria for one of the one or more rate levels for the qualification cycle date range.

4. The method of claim 1, wherein the step of determining in step (h) of claim 46 comprises:
(a) determining whether the designated demand deposit account has an account balance during the qualification cycle that meets a predetermined minimum balance requirement during the qualification cycle date range; and
(b) determining whether the designated demand deposit account qualifies for the application of the non-zero base rates in response to the account balance meeting the predetermined minimum balance requirement.

5. The method of claim 1, wherein the step of determining in step (h) of claim 46 comprises determining whether the designated demand deposit account is a type of account that always pays at least the non-zero base rates.

6. The method of claim 1, wherein the at least one account level qualification criteria comprises one or more criteria selected from a group consisting of:
electronic receipt of account statements;
providing an e-mail address;
previous logging on to an internet website;
meeting a minimum number of debit card transactions;
maintaining a minimum account balance;
meeting a certain number of direct deposits;
performing a number of bill pay transactions;
limiting the number of non-electronic transactions to the account;
referring a friend to the financial institution;
maintaining a qualifying deposit or loan account at the financial institution; and
maintaining a qualifying loan amount.

7. The method of claim 6, wherein the at least one account level qualification criteria comprises at least the criterion of meeting a minimum number of debit card transactions.

8. The method of claim 6, wherein the at least one account level qualification criteria is not solely the criterion of maintaining a minimum account balance.

9. The method of claim 6, wherein the at least one account transaction activity qualification criteria comprises one or more criteria selected from a group consisting of:
a specified minimum number of debit card transactions;
a specified minimum number of ATM withdrawals;
a specified number of bill pay transactions;
a specified number of direct deposits; and
a specified number of direct debits.

10. The method of claim 1, wherein steps (f) thru (k) of the method is executed on the core processor system.

11. The method of claim 1, wherein steps (f) thru (k) of the method is executed by the application program executing remotely from the core processor system over the communications network.

12. The method of claim 11, wherein the step of instructing in step (j) of claim 46 is selected from the group consisting of:
(a) sending an instruction having a rate type comprising a first logical state to the core processor system that directs the core processor system to apply the determined alternate interest rates of the interest rate plan to the applicable portion of the account balance of the designated demand deposit account in the tier for the accounting period;
(b) computing an interest transaction amount for the designated demand deposit account by applying the determined alternate interest rates of the interest rate plan to the applicable portion of the account balance of the designated demand deposit account in the tier for the accounting period and sending an instruction having a rate type for communicating the computed interest transaction amount to the core processor system;
(c) sending an instruction having a rate type for instructing the core processor to apply the determined alternate interest rates of the interest rate plan to the applicable portion of the account balance of the designated demand deposit account in the tier for the accounting period;
(d) sending an instruction having a rate type to the core processor system for notifying the core processor system of the determined alternate interest rates of the interest rate plan to apply to the applicable portion of the account balance of the designated demand deposit account in the tier for the accounting period;
(e) computing an adjustment amount based upon the determined alternate interest rates and sending an instruction having a rate type that communicates the computed interest adjustment amount to the core processor system for the core processor system to apply to an interest amount already accrued or paid by the core processor system;
(f) computing a replacement amount based upon the determined alternate interest rates and sending an instruction having a rate type that communicates the computed replacement amount to the core processor system for the core processor system to replace the interest amount already accrued or paid by the core processor system; and
(g) directing the application program not to send a communication or notification to the core processor system regarding the application of the determined alternate interest rates of the interest rate plan to the applicable portion of the account balance of the designated demand deposit account in the tier for the accounting period.

13. The method of claim 11, wherein the step of instructing in step (k) of claim 46 is selected from the group consisting of:
(a) sending an instruction having a rate type comprising a second logical state to the core processor system that directs the core processor system to apply the non-zero base rates to the designated demand deposit account for the accounting period;
(b) computing an interest transaction amount for the designated demand deposit account by applying the non-zero base rates to the designated demand deposit account for the accounting period and sending an instruction having a rate type for communicating the computed interest transaction amount to the core processor system;
(c) sending an instruction having a rate type for instructing the core processor system to apply the non-zero base rates to the designated demand deposit account for the accounting period;
(d) sending an instruction having a rate type to the core processor system for notifying the core processor system of the non-zero base rates to apply to the designated demand deposit account for the accounting period;
(e) computing an adjustment amount based upon the non-zero base rates and sending an instruction having a rate type that communicates the computed interest adjustment amount to the core processor system for the core processor system to apply to an interest amount already accrued or paid by the core processor system;
(f) computing a replacement amount based upon the non-zero base rates and sending an instruction having a rate type that communicates the computed replacement amount to the core processor for the core processor system to replace the interest amount already accrued or paid by the core processor system; and
(g) directing the program not to send a communication or notification to the core processor system regarding application of the non-zero base rates to the designated demand deposit account for the accounting period.

14. The method of claim 1, wherein the step of instructing in step (j) further comprises accruing an interest amount.

15. The method of claim 1, wherein the step of instructing in step (j) further comprises paying an interest amount.

16. The method of claim 1, wherein the accounting period is an earnings cycle date period, and the earnings cycle date period is synchronous with respect to the qualification cycle date range.

17. The method of claim 1, wherein the accounting period is an earnings cycle date period, and the earnings cycle date period is asynchronous with respect to the qualification cycle date range.

18. The method of claim 1, wherein:
(a) the plurality of tiers comprise a first tier and a second tier, the first tier corresponding to a first account balance range and the second tier corresponding to a second account balance range,
(b) the non-zero base rates comprise a non-zero first base rate for the first tier and a non-zero second base rate for the second tier,
(c) the first tier has a first alternate interest rate, and the second tier has a second alternate interest rate, wherein the first alternate interest rate is a higher-than-market interest rate, and
(d) non-zero base rates comprise the non-zero first base rate and the non-zero second base rate.

19. The method of claim 1, wherein:
(a) the plurality of tiers comprise a first tier and a second tier, the first tier corresponding to a first account balance range and the second tier corresponding to a second account balance range,
(b) the non-zero base rates comprise a non-zero first base rate B₁ for the first tier and a non-zero second base rate B₂ for the second tier,
(c) the one or more rate levels comprise a first rate level, wherein
(i) the first rate level has a first qualification criteria associated therewith, the first qualification criteria comprising at least one account level qualification criteria and at least one account transaction activity qualification criteria, and
(ii) the second rate level has a second qualification criteria associated therewith, the second qualification criteria comprising at least one account level qualification criteria and at least one account transaction activity qualification criteria,
(d) the first rate level includes a first alternate interest rate A₁₁ for the first tier, which is a first higher-than-market interest rate, and a second alternate interest A₁₂ rate for the second tier,
(e) the second rate level includes a first alternate interest rate A₂₁ for the first tier, which is a second higher-than-market interest rate, and a second alternate interest A₂₂ rate for the second tier;
(f) upon the determining that the account criteria data for the designated demand deposit account meets the first qualification criteria but not the second qualification criteria, directing application of the first alternate interest rate A₁₁ and the second alternate interest rate A₁₂ to the designated demand deposit account for the accounting period;
(g) upon the determining that the account criteria data for the designated demand deposit account meets the first qualification criteria and the second qualification criteria, directing application of the first alternate interest rate A₂₁ and the second alternate interest rate A₂₂ to the designated demand deposit account for the accounting period;
(h) upon the determining (i) that the account criteria data for the designated demand deposit account does not meet the first qualification criteria or the second qualification criteria of the interest rate plan, and (ii) that the account criteria data for the designated demand deposit account qualifies for the application of the non-zero first base rate B₁ and the non-zero second base rate B₂, directing application of the non-zero first base rate B₁ and the non-zero second base rate B₂ to the designated demand deposit account for the accounting period.

20. The method of claim 1, wherein:
(a) the plurality of tiers comprise a first tier and a second tier, the first tier corresponding to a first account balance range and the second tier corresponding to a second account balance range,
(b) non-zero base rates comprise a non-zero first base rate B₁ for the first tier and a non-zero second base rate B₂ for the second tier,
(c) the one or more rate levels comprise a first rate level, wherein the first rate level has a first qualification criteria associated therewith, the first qualification criteria comprising at least one account level qualification criteria and at least one account transaction activity qualification criteria,
(d) the first rate level includes a first alternate interest rate A₁ for the first tier, which is a first higher-than-market interest rate, and a second alternate interest rate A₂ for the second tier;
(e) upon the determining that the account criteria data for the designated demand deposit account meets the first qualification criteria, directing application of the first alternate interest rate A₁ and the second alternate interest rate A₂ to the designated demand deposit account for the accounting period; and
(f) upon the determining (i) that the account criteria data for the designated demand deposit account does not meet the first qualification criteria of the interest rate plan, and (ii) that the account criteria data for the designated demand deposit account qualifies for the application of the non-zero first base rate B₁ and the non-zero second base rate B₂, directing application of the non-zero first base rate B₁ and the non-zero second base rate B₂ to the designated demand deposit account for the accounting period.

21. The method of claim 1, wherein:
(a) the rate levels comprise two or more rate levels each comprising a first rate level and a second rate level, wherein the first rate level has a first qualification criteria, (ii) the second rate level has a second qualification criteria, and (iii) the second qualification criteria is the first qualification criteria plus additional account transaction activity qualification criteria,
(b) for each tier (i) the first rate level has a first level alternate interest rate, (ii) the second rate level has a second level alternate interest rate, wherein the second level alternate interest rate is the first level alternate interest rate increased by an additional interest rate amount, and (iii) the additional interest rate amount is based upon the additional account transaction activity qualification criteria.

22. The method of claim 1, wherein:
(a) the one or more rate levels comprise an alternate interest rate for each tier in the plurality of tiers, wherein (i) the alternate interest rates for the one or more rate levels for each tier have qualification criteria associated therewith, (ii) said qualification criteria for the alternate interest rates for a first tier of a first rate level of the plurality of tiers comprises at least one account level qualification criterion and at least one account transaction activity qualification criterion, and (iii) the alternate interest rate for the first rate level for the first tier includes a first alternate interest rate with a higher-than-market interest rate;
(b) upon the determining that the account criteria data for the designated demand deposit account meets the qualification criteria for the one of the alternate interest rates of the interest rate plan for any tier, directing application of the determined alternate interest rate type of the interest rate plan to an applicable portion of the account balance of the designated demand deposit account in the tier for the accounting period;
(c) upon the determining (i) that the account criteria data for the designated demand deposit account does not meet the qualification criteria for the alternate interest rates of the interest rate plan in any tier, and (ii) that the account criteria data for the designated demand deposit account qualifies for the application of the non-zero base rates, directing application of the non-zero base rates to the designated demand deposit account for the accounting period.

23. A computer system for applying alternate interest rates, comprising:
a processor in electronic communication with a core processor system for a financial institution; and
at least one storage device connected to the processor,
wherein the at least one storage device has stored thereon
(x) a program for controlling the processor to implement a method of applying interest rates to demand deposit accounts at a financial institution,
(y) an interest rate plan for applying alternate interest rates to the demand deposit accounts at the financial institution, comprising:
(i) a plurality of tiers for each demand deposit account, wherein the tiers correspond to account balance ranges,
(ii) non-zero base rates comprising a non-zero base rate for each tier in the plurality of tiers,
(iii) one or more rate levels, wherein
(A) each of the rate levels has qualification criteria associated therewith,
(B) the qualification criteria for each of the rate levels comprises at least one account level qualification criteria and at least one account transaction activity qualification criteria,
(C) for each rate level, each tier in the plurality of tiers has an alternate interest rate, and
(D) for each rate level, a first tier in the plurality of tiers has a first alternate interest rate that is a higher-than market interest rate; and
(z) a qualification cycle date range associated with said interest rate plan;
wherein the core processor system stores account criteria data for the demand deposit accounts generated during the qualification cycle date range; and
wherein the processor is operative to execute instructions of the program to implement the method for applying alternate interest rates based upon the interest rate plan;
wherein the method for applying interest rates comprises:
(a) designating a demand deposit account to receive interest based on said interest rate plan;
(b) accessing the qualification cycle date range associated with said interest rate plan;
(c) accessing (i) the qualification criteria for the one or more rate levels and (ii) the account criteria data for the designated demand deposit account during the qualification cycle date range;
(d) determining whether the account criteria data for the designated demand deposit account qualifies for the application of the non-zero base rates for the qualification cycle date range;
(e) determining whether the account criteria data for the designated demand deposit account meets the qualification criteria for one of the one or more rate levels for the qualification cycle date range;
(f) upon determining that the account criteria data for the designated demand deposit account meets the qualification criteria for the one of the one or more rate levels for the qualification cycle date range, instructing the core processor system to apply the alternate interest rates for the determined rate level to the designated demand deposit account for the accounting period, wherein the instructing includes converting the determined rate level into a code for the core processor using the associated rate type, generating an instruction that includes the code, and sending the instruction to the core processor system to adjust the interest paid or accrued by the core processor system for the demand deposit account; and
(g) upon determining (i) that the account criteria data for the designated demand deposit account does not meet the qualification criteria for any of the one or more rate levels of the interest rate plan, and (ii) that the account criteria data for the designated demand deposit account qualifies for the application of the non-zero base rates, instructing the core processor to apply the non-zero base rates to the designated demand deposit account for the accounting period.

24. The system of claim 23, wherein the non-zero base rates of the interest rate comprise the same non-zero base rate for each tier in the plurality of tiers.

25. The system of claim 23, wherein the step of determining in step (e) of claim 70 is a single determination of whether the account criteria data for the designated demand deposit account meets the qualification criteria for one of the one or more rate levels for the qualification cycle date range.

26. The system of claim 23, wherein the step of determining in step (d) of claim 70 comprises:
(a) determining whether the calculated account balance meets a predetermined minimum balance requirement during the qualification cycle date range; and
(b) determining whether the account criteria data for the designated demand deposit account qualifies for the application of the non-zero base rates in response to the account balance meeting the predetermined minimum balance requirement.

27. The system of claim 23, wherein the step of determining in step (d) of claim 70 comprises determining whether the designated demand deposit account is a type of account that always pays at least the non-zero base rates.

28. The system of claim 23, wherein the at least one account level qualification criteria comprises one or more criteria selected from a group consisting of:
electronic receipt of account statements;
providing an e-mail address;
previous logging on to an internet website;
meeting a minimum number of debit card transactions;
maintaining a minimum account balance;
meeting a certain number of direct deposits;
performing a number of bill pay transactions;
limiting the number of non-electronic transactions to the account;
referring a friend to the financial institution;
maintaining a qualifying deposit or loan account at the financial institution; and
maintaining a qualifying loan amount.

29. The system of claim 28, wherein the at least one account level qualification criteria comprises at least the criterion of meeting a minimum number of debit card transactions.

30. The system of claim 28, wherein the at least one account level qualification criteria is not solely the criterion of maintaining a minimum account balance.

31. The system of claim 28, wherein the at least one account transaction activity qualification criteria comprises one or more criteria selected from a group consisting of:
a specified minimum number of debit card transactions;
a specified minimum number of ATM withdrawals;
a specified number of bill pay transactions;
a specified number of direct deposits; and
a specified number of direct debits.

32. The system of claim 23, wherein the system includes a core processor system which executes the program.

33. The system of claim 23, wherein the computer system executing the program for implementing the method is in electronic communication over a network with a core processor system located remotely from the computer system.

34. The system of claim 33, wherein the step of instructing in step (f) of claim 70 is selected from the group consisting of:
(a) sending an instruction having a rate type comprising a first logical state to the core processor system that directs the core processor system to apply the determined alternate interest rates of the interest rate plan to the applicable portion of the account balance of the designated demand deposit account in the tier for the accounting period;
(b) computing an interest transaction amount for the designated demand deposit account by applying the determined alternate interest rates of the interest rate plan to the applicable portion of the account balance of the designated demand deposit account in the tier for the accounting period and sending an instruction having a rate type for the computed interest transaction amount to the core processor system;
(c) sending an instruction having a rate type for instructing the core processor system to apply the determined alternate interest rates of the interest rate plan to the applicable portion of the account balance of the designated demand deposit account in the tier for the accounting period;
(d) sending an instruction having a rate type to the core processor system for notifying the core processor system of the determined alternate interest rates of the interest rate plan to apply to the applicable portion of the account balance of the designated demand deposit account in the tier for the accounting period;
(e) computing an adjustment amount based upon the determined alternate interest rates and sending an instruction having a rate type that communicates the computed interest adjustment amount to the core processor system for the core processor system to apply to an interest amount already accrued or paid by the core processor system;
(f) computing a replacement amount based upon the determined alternate interest rates and sending an instruction having a rate type that communicates the computed replacement amount to the core processor system for the core processor system to replace the interest amount already accrued or paid by the core processor system; and
(g) directing the program not to send a communication or notification to the core processor system regarding the application of the determined alternate interest rates of the interest rate plan to the portion of the account balance of the designated demand deposit account in the tier for the accounting period.

35. The system of claim 33, wherein the step of instructing in step (g) of claim 70 is selected from the group consisting of:
(a) sending an instruction having a rate type comprising a second logical state to the core processor system that directs the core processor system to apply the non-zero base rates to the designated demand deposit account for the accounting period;
(b) computing an interest transaction amount for the designated demand deposit account by applying the non-zero base rates to the designated demand deposit account for the qualification cycle date range and sending an instruction having a rate type for communicating the computed interest transaction amount to the core processor system;
(c) sending an instruction having a rate type for instructing the core processor system to apply the non-zero base rates to the designated demand deposit account for the accounting period;
(d) sending an instruction having a rate type to the core processor system for notifying the core processor system of the non-zero base rates to apply to the designated demand deposit account for the accounting period;
(e) computing an adjustment amount based upon the non-zero base rates and sending an instruction having a rate type that communicates the computed interest adjustment amount to the core processor system for the core processor system to apply to an interest amount already accrued or paid by the core processor system;
(f) computing a replacement amount based upon the non-zero base rates and sending an instruction having a rate type that communicates the computed replacement amount to the core processor system for the core processor system to replace the interest amount already accrued or paid by the core processor system; and
(g) directing the program not to send a communication or notification to the core processor system regarding application of the non-zero base rates to the designated demand deposit account for the accounting period.

36. The system of claim 23, wherein applying an alternate interest rate includes accruing an interest amount.

37. The system of claim 23, wherein applying an alternate interest rate includes paying an interest amount.

38. The system of claim 23, wherein the accounting period is an earnings cycle date period, and the earnings cycle date period is synchronous with respect to the qualification cycle date range.

39. The system of claim 23, wherein the accounting period is an earnings cycle date period, and the earnings cycle date period is asynchronous with respect to the qualification cycle date range.

40. A computer program product stored on a non-transitory computer readable medium, said computer program product having instructions for execution by a computer system, wherein the instructions, when executed by the computer system, cause the computer system to implement a method for applying alternate interest rates to demand deposit accounts at a financial institution, the method implemented by the computer system executing the instructions comprising:
(a) providing an interest rate plan for applying interest rates to demand deposit accounts at a financial institution comprising
(i) a plurality of tiers for each demand deposit account, wherein the tiers correspond to account balance ranges,
(ii) non-zero base rates comprising a non-zero base rate for each tier in the plurality of tiers,
(iii) one or more rate levels, wherein
(A) each of the rate levels has qualification criteria associated therewith,
(B) the qualification criteria for each of the rate levels comprises at least one account level qualification criteria and at least one account transaction activity qualification criteria,
(C) for each rate level, each tier in the plurality of tiers has an alternate interest rate, and
(D) for each rate level, a first tier in the plurality of tiers has a first alternate interest rate that is a higher-than market interest rate;
(b) designating a demand deposit account at the financial institution to receive interest based on said interest rate plan;
(c) accessing, via the computer system, a qualification cycle date range associated with said interest rate plan;
(d) associating a core processor for the financial institution with a rate type from a plurality of rate types that is suitable for communicating the one or more rate levels to the core processor system over a communications link;
(e) accessing, via the computer system, (i) the qualification criteria for the one or more rate levels and (ii) account criteria data for the designated demand deposit account during the qualification cycle date range from the core processor over the communications link;
(f) determining whether the account criteria data for the designated demand deposit account qualifies for the application of the non-zero base rates for the qualification cycle date range;
(g) determining, via the computer system, whether the account criteria data for the designated demand deposit account meets the qualification criteria for one of the one or more rate levels for the qualification cycle date range;
(h) upon determining that the account criteria data for the designated demand deposit account meets the qualification criteria for the one of the one or more rate levels for the qualification cycle date range, instructing the core processor system to apply the alternate interest rates for the determined rate level to the designated demand deposit account for the accounting period, wherein the instructing includes converting the determined rate level into a code for the core processor using the associated rate type, generating an instruction that includes the code, and sending the instruction to the core processor system to adjust the interest paid or accrued by the core processor system for the demand deposit account;
(i) upon determining (i) that the account criteria data for the designated demand deposit account does not meet the qualification criteria for any of the one or more rate levels of the interest rate plan, and (ii) that the account criteria data for the designated demand deposit account qualifies for the application of the non-zero base rates, instructing the core processor system to apply the non-zero base rates to the designated demand deposit account for the accounting period.

41. A computer-implemented method for applying alternate interest rates to accounts at a financial institution, the method comprising:
(a) providing an interest rate plan for applying interest rates to a demand deposit account at the financial institution comprising
(i) a plurality of tiers for the demand deposit account, comprising a first tier and a second tier, the first tier corresponding to a first account balance range and the second tier corresponding to a second account balance range,
(ii) non-zero base rates comprising a non-zero first base rate B₁ for the first tier and a non-zero second base rate B₂ for the second tier,
(iii) one or more rate levels, wherein
(A) each of the rate levels has qualification criteria associated therewith,
(B) the one or more levels comprise a first rate level, wherein the first rate level has a first qualification criteria associated therewith, the first qualification criteria comprising at least one account level qualification criteria and at least one account transaction activity qualification criteria,
(C) the one or more levels comprise a second rate level, wherein the second rate level has a second qualification criteria associated therewith, the second qualification criteria comprising at least one account level qualification criteria and at least one account transaction activity qualification criteria,
(D) for each rate level, each tier in the plurality of tiers has an alternate interest rate,
(E) the first rate level includes a first alternate interest rate A₁₁ for the first tier, which is a first higher-than-market interest rate, and a second alternate interest rate A₁₂ for the second tier, and
(F) the second rate level includes a first alternate interest rate A₂₁ for the first tier, which is a second higher-than-market interest rate, and a second alternate interest rate A₂₂ for the second tier;
(b) designating the demand deposit account to receive interest based on said interest rate plan;
(c) providing an application program for implementing the method in communication with a core processor system for the financial institution over a communications means;
(d) associating the core processor system with a rate type from a plurality of rate types that is suitable for communicating the one or more rate levels to the core processor system,
(e) providing at least one memory accessible by the application program that includes:
(i) the interest rate plan;
(ii) a qualification cycle date range for the interest rate plan;
(iii) account level qualification criteria for the one or more rate levels for the financial institution, wherein the account level qualification criteria comprises one or more criteria selected from a group consisting of:
electronic receipt of account statements;
providing an e-mail address;
previous logging on to an internet website;
meeting a minimum number of debit card transactions;
maintaining a minimum account balance;
meeting a certain number of direct deposits;
performing a number of bill pay transactions;
limiting the number of non-electronic transactions to the account;
referring a friend to the financial institution;
maintaining a qualifying deposit or loan account at the financial institution; and
maintaining a qualifying loan amount;
(iv) account transaction activity qualification criteria for the one or more rate levels for the financial institution wherein the account transaction activity qualification criteria comprises one or more criteria selected from a group consisting of:
a specified minimum number of debit card transactions;
a specified minimum number of ATM withdrawals;
a specified number of bill pay transactions;
a specified number of direct deposits; and
a specified number of direct debits; and
(f) accessing, via the application program, the qualification cycle date range associated with said interest rate plan;
(g) accessing, via the application program, (i) the qualification criteria for the one or more rate levels and (ii) account criteria data for the designated demand deposit account during the qualification cycle date range;
(h) determining whether the account criteria data for the designated demand deposit account qualifies the demand deposit account for the application of the non-zero base rates for an accounting period;
(i) determining, via the application program, whether the account criteria data for the designated demand deposit account meets the qualification criteria for one of the one or more rate levels for the qualification cycle date range;
(j) upon determining that the account criteria data for the designated demand deposit account meets the qualification criteria for the one of the one or more rate levels for the qualification cycle date range, instructing the core processor system over the communication means to apply the alternate interest rates for the determined rate level to the designated demand deposit account for the accounting period wherein the instructing includes converting the determined rate level into a code for the core processor using the associated rate type, generating an instruction that includes the code, and sending the instruction to the core processor system to adjust the interest paid or accrued by the core processor system for the demand deposit account;
wherein, upon the determining that the account criteria data for the designated demand deposit account meets the first qualification criteria, the instructing the core processor system over the communication means to apply the alternate interest rates for the determined rate level includes directing application of the first alternate interest rate A₁₁ and the second alternate interest rate A₁₂ to the designated demand deposit account for the accounting period; and
wherein upon the determining that account criteria data for the designated demand deposit account meets the second qualification criteria but not the first qualification criteria, directing application of the first alternate interest rate A₂₁ and the second alternate interest rate A₂₂ to the designated demand deposit account for the accounting period;
(k) upon determining (i) that the account criteria data for the designated demand deposit account does not meet the qualification criteria for any of the one or more rate levels of the interest rate plan, and (ii) that the account criteria data for the designated demand deposit account qualifies for the application of the non-zero base rates, instructing the core processor system to apply the non-zero base rates to the designated demand deposit account for the accounting period;
wherein upon the determining (i) that the account criteria data for the designated demand deposit account does not meet the first qualification criteria or the second qualification criteria of the interest rate plan, and (ii) that the account criteria data for the designated demand deposit account qualifies for the application of the non-zero first base rate B₁ and the non-zero second base rate B₂, directing application of the non-zero first base rate B₁ and the non-zero second base rate B₂ to the designated demand deposit account for the accounting period,
wherein the plurality of rate types from which the associated rate type is selected comprises:
(i) a rate type comprising a first logical state that directs the core processor system to apply the determined alternate interest rates of the interest rate plan to the applicable portion of the account balance of the designated demand deposit account in the tier for the accounting period;
(ii) a rate type comprising a computed interest transaction amount for the designated demand deposit account;
(iii) a rate type that applies the determined alternate interest rates of the interest rate plan to the applicable portion of the account balance of the designated demand deposit account in the tier for the accounting period;
(iv) a rate type that notifies the core processor system of the determined alternate interest rates of the interest rate plan to apply to the applicable portion of the account balance of the designated demand deposit account in the tier for the accounting period;
(v) a rate type that communicates a computed interest adjustment amount to the core processor system for the core processor system to apply to an interest amount already accrued or paid by the core processor system;
(vi) a rate type that communicates a computed replacement amount to the core processor system for the core processor system to replace the interest amount already accrued or paid by the core processor system; and
(vii) a rate type that directs the application program not to send a communication or notification to the core processor system regarding the application of the determined alternate interest rates of the interest rate plan to the applicable portion of the account balance of the designated demand deposit account in the tier for the accounting period.
